(19) United States
(12) Patent Application Publication
(10) Pub. No.: US 2006/0225837 A1
(43) Pub. Date: Oct. 12, 2006

(54) Method and device for attaching advertising media to bottles

(76) Inventor: Wolfgang Haase, Ebersbach/Fils (DE)

Correspondence Address: JORDAN AND HAMBURG LLP, 122 EAST 42ND STREET, SUITE 4000, NEW YORK, NY, 10168, US

(21) Appl. No.: 10/565,318

(22) PCT Filed: Jul. 9, 2003
(86) PCT No.: PCT/EP03/07370

§ 371 Date: Feb. 1, 2006

(51) Int. Cl. B32B 38/18; B32B 37/00

(52) U.S. Cl. 156/281; 156/272.2; 156/277; 156/539; 156/556; 156/363

(57) ABSTRACT

The invention relates to a method for attaching advertising media to bottles. In a first step, caps or sealing parts for bottles are continuously transported into predetermined designated positions. The labels that constitute the advertising media are subsequently attached to the caps or sealing parts. The caps or sealing parts with their attached labels are then sterilized.

### BACKGROUND OF THE INVENTION

The invention relates to a method for applying media carriers to bottles.

Such bottles can in particular constitute mineral water, fruit juice, beer, or lemonade bottles.

In principle, the bottles can comprise glass or plastic, in particular PET. Labels are applied to the bodies of the bottles in a known manner for identifying the bottle contents. These labels also act in particular as advertising media, the name and logo of the manufacturing firm and any additional advertising information being added thereto.

In the case of reusable beverage bottles, the labels are removed from the bodies of the empty bottles during a sterilizing process, whereupon the bottles are refilled and then provided with new labels.

Known labels of this type are glued to the bodies of the bottles by means of an adhesive while the bottles are being processed in a bottle filling system. In order to ensure that the labels have the required adhesion to the bottles, the labels are affixed to the bottles such that the labels cannot be removed from the bottles manually without being destroyed.

This limits the utility of such labels as advertising media in an undesired manner.

Known from DE 102 28 292 A1 is a method for applying advertising media to bottles in which in a first method step caps or sealing parts for bottles are sorted for their continuous conveyance to pre-specified target positions. There the labels constituting advertising media are applied to the caps or sealing parts. Finally, the completely finished caps that have been provided with the advertising media are collected in supply containers, whereupon the caps stored in the supply containers can be fed non-continuously to a bottle filling system.

Using this method, caps of bottles can be used as carriers for advertising media, whereby the bottles in general can be embodied as mineral water, fruit juice, beer, or lemonade bottles.

### BRIEF SUMMARY OF THE INVENTION

Starting from this prior art, the object of the invention is to provide a method and an apparatus for applying advertising media to bottles, which method can be performed in a rational manner in terms of production engineering and still complies with the applicable regulations regarding processing of foods. The inventive method applies advertising media to bottles and encompasses the following method steps. In a first method step, caps or sealing parts for bottles are continuously transported to pre-specified target positions. There the labels constituting advertising media are applied to the caps or sealing parts. Then the caps or sealing parts with the applied labels are sterilized.

Production of sterilized units comprising the advertising media and caps is attained in a simple and rational manner by sterilizing the caps or sealing parts after applying the labels. These sterilized units can be used as they are without additional complexity in the production processes in the individual bottle filling systems, it being particularly advantageous that these production processes do not have to be modified or adapted thereto.

In accordance with a first variant of the invention, the caps can be applied to the bottles before the advertising media are applied to the caps. The labeling machine provided for this and any downstream disinfecting units for sterilizing the top sides of the caps that are provided with labels can be simply integrated into conventional bottle filling systems as modular units.

In one particularly advantageous second variant of the invention, which will be referenced in the following, caps or sealing parts are fed to labeling machines individually as separate units via conveying means in order to then apply to them the labels as advertising media.

Downstream of each labeling machine, then, is a disinfecting unit in which the caps or sealing parts are conveyed in a continuous process and exposed to UV radiation or sprayed with disinfectants in order to sterilize these units preferably on all sides.

This apparatus is preferably situated in a cleanroom in order to ensure germ-free processing.

Attached to the outputs of the disinfecting units are supply containers that are coupled to the disinfecting units via air-tight connectors. In particular plastic bags can be provided as supply containers. In each case, the sterilized caps or sealing parts are added directly to the supply containers via the air-tight connectors and are stored there sterile without coming into contact with the exterior air.

If sterilization is performed with liquid disinfectants, such as peracetic acid or hydrogen peroxide, the thus sterilized caps or sealing parts are dried with purified air before being added to the supply containers.

Such post-treatment is not necessary when sterilization is by means of UV radiation.

The caps or sealing parts thus packed can be inserted into the production process in bottle filling systems in a simple manner, whereby the sterility of these units is assured at all times.

The caps form a flexible carrier for advertising media. The advertising media can in particular be attached to the top sides of the caps so that they are immediately visible on the exterior of the bottle to any purchaser. It is particularly advantageous that nearly the entire surface of the caps can be used to receive the advertising media.

Since manufacturing companies and operators of bottle filling systems alone use the labels applied to the bodies of the bottles as information surfaces, the surfaces on the caps are available in their entirety for receiving advertising media of third-party companies.

The caps themselves and also the advertising media applied thereto are extremely convenient and easy to manage. They are thus also in particular suitable as collectibles.

The caps comprise metal or plastic and can be embodied as one piece.

In particular in the case of caps comprising metal, the sterility of such units represents a significant problem in production processes in bottle filling systems.

In one particularly advantageous embodiment, the caps are embodied in two pieces, whereby a cap comprises a cap body part and a separate cover that is mechanically joined to the cap body part. The advertising media are then applied to the cover of the caps prior to their final assembly. Particularly advantageous, the covers are detachably applied to the cap body parts so that the covers with the advertising media can be manually detached and thus can be used as collectibles.

This embodiment is particularly suitable for caps that comprise plastic, in particular PET (polyethylene) and that are embodied as screw-on caps.

In general the caps can be embodied as rolled-on closures, crown seals, tube caps, or the like.

The advertising media themselves are embodied in the form of labels that are applied to the caps by machine.

Advertisements of all types, in particular advertisements from third-party companies, can be applied using printed material. In particular letterpress printing, offset printing, screen printing processes, printing methods, and combinations thereof are used for this.

The printed images on the labels contain in particular logos and advertising slogans of third-party companies. The labels can furthermore be used as collectibles and/or gaming items.

When used as collectibles, the labels are preferably removed from the caps. Alternatively, in the case of caps embodied in a plurality of parts, the caps with the labels applied thereto can be collectibles.

When used as gaming items, the advertising media can for instance be used for applying lottery numbers for raffle-type contests.

In such applications, the labels as advertising media have in particular appropriately selected coatings in order to achieve further advertising aims.

One example of this is applying temperature-sensitive coatings to the labels. The temperature-sensitive layers can for instance be embodied such that the color of a label changes as the temperature changes. Furthermore, the coatings can be embodied such that patterns or printed images on a label do not become visible until a certain limiting temperature is attained.

In one advantageous embodiment, the labels can be coated with diffusion film. Using light-scattering effects, so-called lenticular images are generated, different images or print motifs on the advertising media become visible depending on the viewing angle.

In another embodiment, the labels can be coated with reflective films. The highly light-reflecting advertising media thus embodied can be used as signal marks in the leisure time field. In particular these can be attached to bicycles, bicycle helmets, roller blades, roller skates, ice-skates, or even articles of clothing.

In another variant, fluorescing films can also be applied to the labels. Using the luminescence of such advertising media, they can be used as signal marks in dark rooms or generally in an unilluminated environment. For instance, the advertising media thus embodied can be used in unilluminated hallways in buildings to signal escape routes, to mark light switches, or the like.

In another preferred embodiment, rub-off surfaces can be applied to the labels as coatings. The labels then preferably have a stable intermediate coating that mechanically protects the printed material on a label. Then a top layer that forms the rub-off surface and that completely covers this printed material is attached. When the top layer is removed, the printed material situated thereunder becomes visible. Such advertising media are preferably used for collectibles or gaming items.

These labels can be punched or embossed, enhancing the overall esthetic effect of the labels. Suitable processing methods are in particular film embossing, hologram methods, in particular embossed holograms, relief embossing, and blind blocking. The embossing methods can be combined with punches, in particular front and back side punches in the labels. Additional suitable processing methods are laminating methods. In addition, the labels can be siliconized.

### BRIEF DESCRIPTION OF THE DRAWINGS

Accompanying the specification are figures which assist in illustrating the embodiments of the invention, in which:

FIGS. 1a and 1b illustrate two exemplary embodiments of caps for beverage bottles;

FIG. 2 is a flow-diagram of a first exemplary embodiment of an apparatus for applying advertising media to caps for beverage bottles;

FIG. 3 is a schematic depiction of a first segment of the apparatus in accordance with FIG. 2 with conveying means for transporting caps;

FIG. 4 is a schematic depiction of a first embodiment of a disinfecting unit for the apparatus in accordance with FIG. 2;

FIG. 5 is a detailed depiction of the disinfecting unit in accordance with FIG. 4;

FIG. 6 is a detailed depiction of a second embodiment of a disinfecting unit for the apparatus in accordance with FIG. 2;

FIG. 7a is a detailed depiction of a longitudinal section of the disinfecting unit in accordance with FIG. 6;

FIG. 7b is a detailed depiction of a cross-section of the disinfecting unit in accordance with FIG. 6; and

FIG. 8 is a schematic depiction of a second embodiment of an apparatus for applying advertising media to caps of beverage bottles.

### DETAILED DESCRIPTION OF THE INVENTION

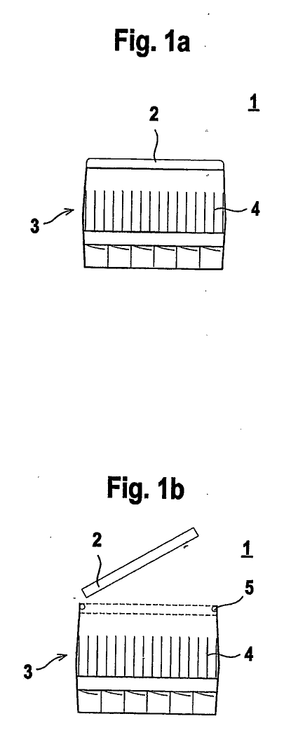

FIGS. 1a and 1b illustrate two exemplary embodiments of caps 1 of bottles, in particular beverage bottles. The caps 1 depicted in FIGS. 1a and 1b comprise plastic, in particular PET, and each is used as a screw-on cap. Such caps 1 are used in particular for beverage bottles comprising plastic, in particular PET bottles.

While the cap 1 depicted in FIG. 1a is embodied in one piece, the cap 1 in accordance with FIG. 1b comprises two separate parts, specifically a cap body part 2 and a sealing part in the form of a cover 3. The cap body part 2 is embodied largely as a hollow cylinder and has on its interior wall a thread 4 for screwing onto a bottle. The cap part is embodied as a circular disk-shaped cover 3 that can be inserted into the opening on the top side of the cap body part 2. In the present case the cover 3 can be snapped onto the cap body part 2. The edge on the top side of the cap body part 2 that limits the opening can be easily bent up in order to insert the cover 3 into the opening. A locking means is provided at the top end of the opening for fixing the cover 3. It comprises a reinforcing ring 5 that runs in the circumferential direction on the interior side of the cap body part 2 and that is embodied in one piece with the wall of the cap body part 2.

In general provided on the cap body part 2 is a seat on which the cap 3 can be fixed as a cap part, whereby the cover 3 can in particular be pushed onto and/or locked onto the cap body part 2. The cover 3 can also be detachably joined to the cap body part 2.

In other embodiments, the caps 1 can also be embodied as rolled-on closures, crown seats, tube caps, and the like and can comprise metal and/or plastic.

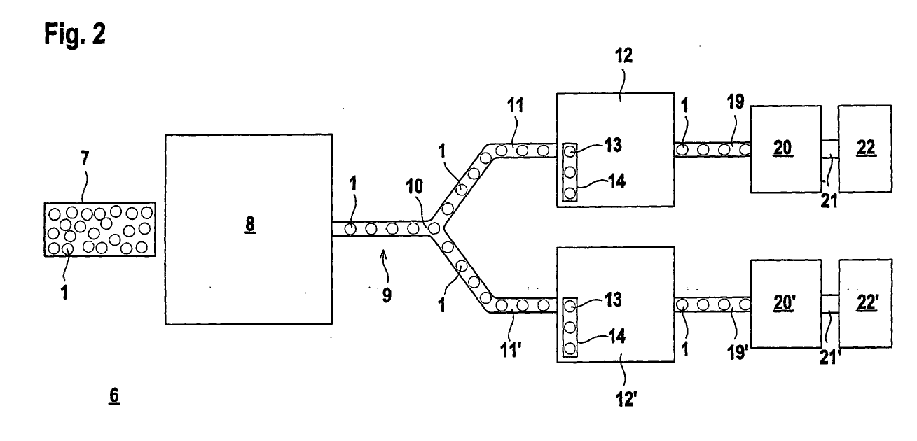

FIG. 2 illustrates one exemplary embodiment of an apparatus 6 for applying advertising media to caps 1 in accordance with FIG. 1a. The apparatus 6 has a roller transport belt 7 on which the caps 1 are fed unsorted to a separating unit. In the present instance the latter is embodied as a centrifugal sorter 8.

The caps 1 are sorted in the centrifugal sorter 8 such that they are output individually, one after the other and with cover surfaces on top, on a conveyor segment 9 constituting conveying means. On its lateral edges this conveyor segment 9 has guides (not shown in detail) that ensure lateral positioning of the caps 1. Thus the caps 1 are transported positioned precisely one after the other on the conveyor segment 9.

The conveyor segment 9 has a switch 10 by means of which the caps 1 that are conveyed one after the other are separated into two parallel segments 11, 11′. The switch 10 preferably has diverting means (not shown) by means of which the supplied caps 1 are fed to the two segments 11, 11′ in an alternating manner. The caps 1 transported on each segment 11, 11′ are fed to a labeling machine 12, 12′. The segments 11, 11′ are identical and the labeling machines 12, 12′ are identical. Labels 13 that constitute the advertising media are applied to the cover surfaces of the caps 1 in the labeling machines 12, 12′. The labels 13 are preferably embodied as self-stick labels and preferably comprise paper and/or plastic. The labels 13 can be embodied in one or a plurality of layers onto which printed material, coatings, punches, embossing, or the like has/have been applied.

The labels 13 are applied in a known manner to belt-like carriers 14. These carriers 14 are conducted via appropriate conveying systems to the caps 1, upon which the labels 13 are then glued to the cover surfaces of the caps 1 by means of known techniques.

Since the caps 1 are fed in parallel to two labeling machines 12, 12′, the throughput of the apparatus 6 is substantially improved compared to a single-track process.

The labels 13 as advertising media can be applied using sensor signals so that the labels 13 are applied precisely and centered on the cover surfaces of the caps 1. The sensor signals are generated by means of appropriate sensors that detect whether a cap 1 is situated in a pre-determined target position in which the label is to be applied.

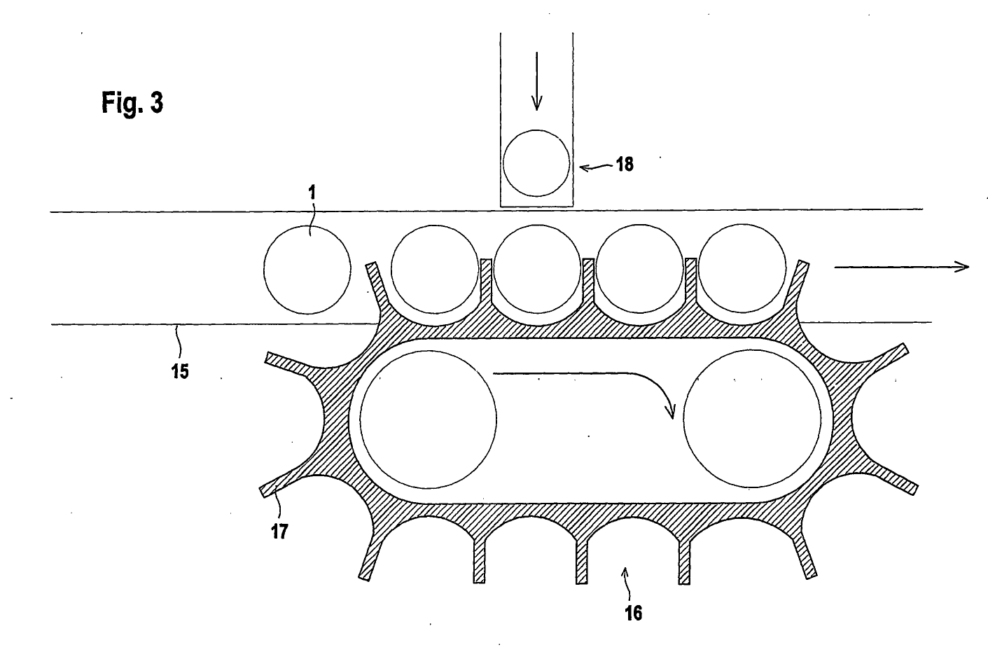

FIG. 3 illustrates a largely mechanical arrangement for introducing the caps 1 into the target positions.

The caps 1 are conveyed individually one after the other in the area of the labeling machine 12, 12′ on a conveyor belt 15 in the transport direction indicated with the arrow. In the simplest case, the conveyor belts 15 are embodied as extensions of the segments 11, 11′ of the conveyor segment 9.

Although caps 1 are conveyed laterally on the conveyor belt 15, the distances between successive caps 1 can vary.

In order to attain equidistant transport of caps 1 to the target positions, the mechanical means for guided transport of the caps 1 are allocated to the conveyor belt 15. These means largely comprise a motor-driven continuous conveyor 16. The continuous conveyor 16 has identical gripping arms 17 that circle in one plane and that are arranged successively in the conveying direction.

The plane of the gripping arms 17 runs in the transport plane of the gripping arms 17. The direction of rotation of the gripping arms 17 is matched to the direction of transport of the caps 1 such that the gripping arms 17 are moved to the caps 1 at the beginning of the side of the continuous conveyor 16 that faces the conveyor belt 15 and finally engage laterally in the intermediate spaces between two successive caps 1.

Thus guided transport of the caps 1 occurs along the longitudinal side of the continuous conveyor 16 such that two successive caps 1 are separated from one another by one gripping arm 17. The shapes of the gripping arms 17 are adapted to the shapes of the caps 1 so that the latter are borne between two gripping arms 17 with no play.

This guided transport and coordination of the movements of the conveyor belt 15 and the continuous conveyor 16 ensure that the caps 1 are fed to a processing head 18 precisely positioned for applying a label 13 in a target position.

The apparatus 6 in accordance with FIG. 2 is furthermore also suitable for applying advertising media to the caps 1 that are embodied in two parts in accordance with FIG. 1a.

In a first embodiment, the covers 3 of the caps 1 can be applied to the cap body parts 2 before the latter are fed to the apparatus 6 in accordance with FIG. 2. In this case the labels 13 are applied to the completely finished caps 1.

In one alternative embodiment, the covers 3 alone are fed to the apparatus 6, the advertising media then being applied to the covers 3 as individual parts. In this case, the individual components of the apparatus 6, in particular the sorting and separating unit as well as the conveyor segment 9, are appropriately modified and adapted for individually processing the covers 3. The caps 1 are then finally assembled downstream of the labeling processes in the labeling machines 12, 12′.

As can be seen from FIG. 2, after the labels 13 have been applied the caps 1 are transported via additional conveyor belts 19, 19′ to a disinfecting unit 20, 20′ in which the caps 1 with the applied labels 13 are sterilized.

This processing is preferably performed under cleanroom conditions in order to prevent contamination of the caps 1 during processing of the caps 1, in particular while they are being sterilized.

The sterilized caps 1 are conducted via air-tight connectors 21, 21′ at the outputs of the disinfecting units 20, 20′ into supply containers 22, 22′ and stored sterile therein.

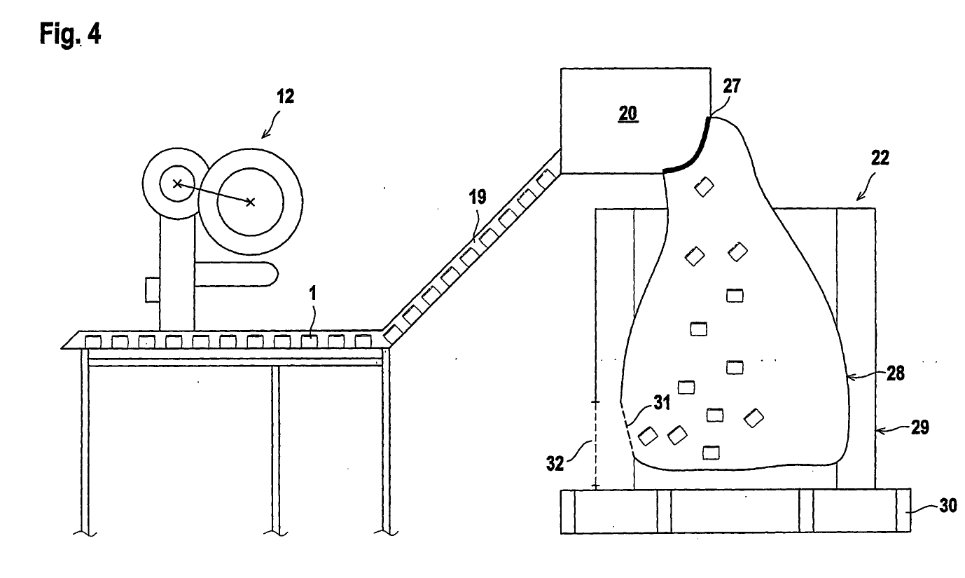

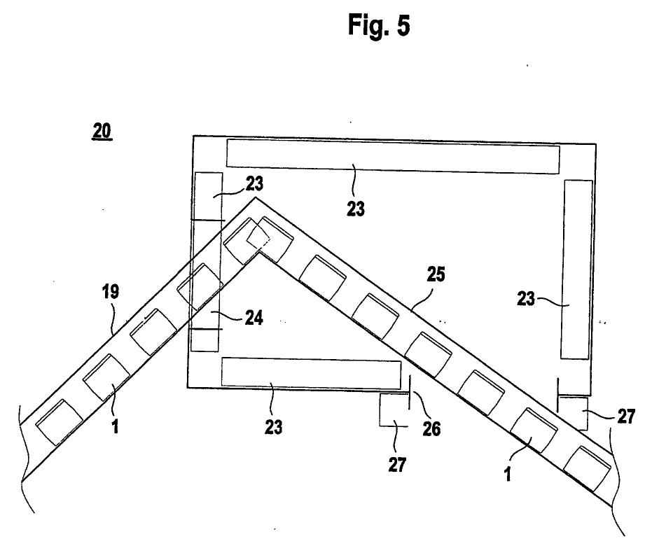

FIGS. 4 and 5 illustrate a first embodiment of such a disinfecting unit of 20. As can be seen from FIG. 4, the caps 1, to which the labels 13 have been applied by means of the labeling machine 12, are fed to the disinfecting unit 20, the conveyor belt 19 that runs on an upward incline being provided for this purpose.

The disinfecting unit 20 is illustrated in detail in FIG. 5. The walls of the disinfecting unit 20 that limit the closed interior space are provided with UV (ultraviolet) radiation sources 23 that emit UV radiation.

The UV radiation sources 23 are in the form of large-area radiators, each of which comprises an array of UV lamps, in particular also semiconductor UV sources. The individual radiation sources are controlled by a control unit (not shown) that is formed by a microprocessor or the like. The UV radiation sources 23 can be operated both in pulse operations and in continuous operation. The radiant intensity of the UV radiation sources 23 can in particular be adjusted using the control unit.

The caps 1 provided with the labels 13 are transported on the conveyor belt 19 through an input opening 24 into the disinfecting unit 20. There the caps 1 are transported along a pre-determined path by means of a conveyor 25. In principle the path can run on one plane. In the present case, the caps 1 are transported along a three-dimensional path by means of the conveyor 25 before the path travels out of the disinfecting unit 20 via an output opening 26.

The path runs such that the entire surface of the caps 1 are transported at pre-determined intervals to the UV radiation sources 23 so that the caps 1 are uniformly subjected to UV radiation on all sides for a pre-determined radiation period at pre-determined radiant intensities. Thus uniform sterilization is assured on all of the surfaces of the caps 1.

The conveyor 25 can preferably comprise UV-transparent materials so that the components of the conveyor 25 do not shade the UV radiation. Alternatively or in addition, rotating, tilting, pivoting, and/or lifting mechanisms, for instance, can be provided on the conveyor 25, by means of which mechanisms the caps 1 are positioned inside the disinfecting unit 20 such that their surfaces are uniformly subjected to UV radiation.

An air-tight connector 21 with a flange 27 is located at the output opening 26 of the disinfecting unit 20. The sterilized caps 1 are introduced from the disinfecting unit 20 into the supply container 22 directly and without contact with the external atmosphere via the air-tight connector 21.

As can be seen from FIG. 4, the supply container 22 comprises a sterile treated plastic bag 28 that is stored in an octabin 29 that stands on a europalette 30.

In these plastic bags 28 the sterilized caps 1 that have been provided with the advertising media are fed to the bottle filling systems. There the caps 1 are applied to beverage bottles.

The plastic bag 28 has a pre-determined breaking point 31 at its lower end for removing the caps 1 therefrom. By opening the plastic bag 28, the caps 1 can be removed therefrom and conducted out of the supply container 22 via a discharge opening 32 in the octabin 29.

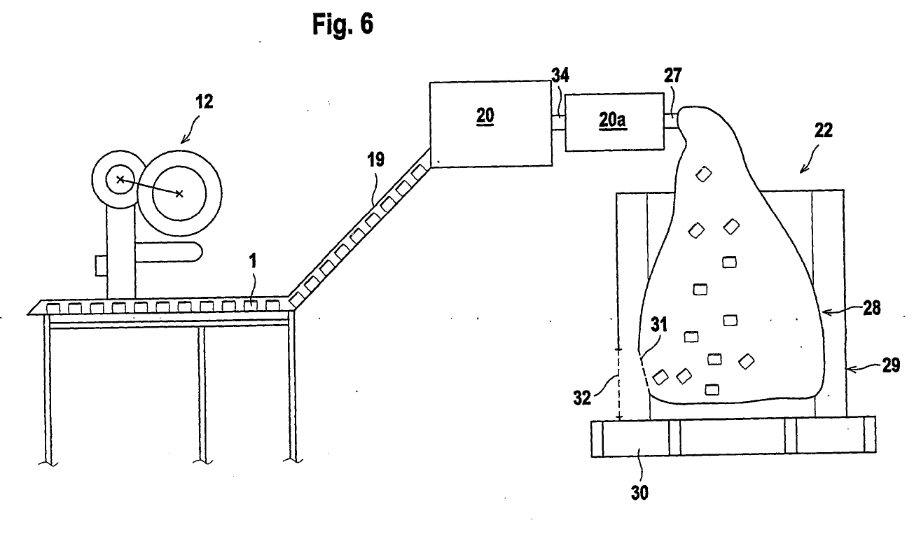

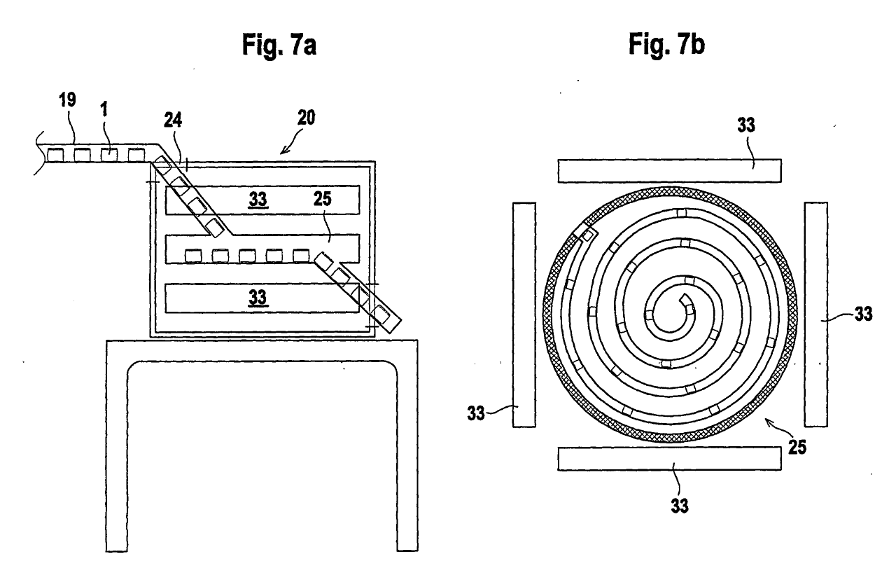

FIGS. 6 and 7a, 7b illustrate a second embodiment of a disinfecting unit 20. The input-side coupling from the disinfecting unit 20 to the labeling machines 12 via the conveyor belt 19 and the output-side coupling to the supply container 22 correspond to the embodiment in accordance with FIGS. 4 and 5. The same applies to the design of the supply container 22 as a plastic bag 28.

Like the disclosed embodiment, the disinfecting unit 20 illustrated in detail in FIGS. 7a and 7b has an input opening 24 via which the caps 1 are fed to a conveyor 25 in the interior of the disinfecting unit 20. In addition, an output opening 26 for discharging the sterilized caps 1 is provided here, as well.

In the present case, provided in the disinfecting unit 20 are spray units 33 comprising two-dimensional multiple arrangements with nozzles by means of which liquid disinfectants such as for instance peracetic acid or hydrogen peroxide are sprayed on the caps 1 to sterilize them.

Alternatively, the caps 1 transported on the conveyor 25 can be dipped into a bath with disinfectant.

The arrangement of the spray units 33 on the one hand and the design of the conveyor 25 are again designed such that the disinfectant acts on the caps 1 uniformly and on all sides.

The disinfectant is conducted at a pre-determined pressure via the nozzles of the spray units 33 and thus directed against the caps 1.

As can be seen from FIG. 7b, in the present case the path of the conveyor 25 is in a spiral shape in one plane. In general wandering paths are also possible in the three-dimensional space.

The caps 1 sterilized in the disinfecting unit 20 are fed to a compressed air unit 20a via the output opening 26 using an air-tight sealed line 34. There the sterilized caps 1 are dried. The compressed air unit 20a is a component of the disinfecting unit 20.

Located at the output of the compressed air unit 20a is the flange 27 to which the plastic bag 28 is attached. The drive and sterilized caps 1 are collected therein as in the embodiment in accordance with FIGS. 4 and 5.

In the embodiments in accordance with FIGS. 2-6, the caps 1 are fed to the bottle filling systems in a non-continuous process. What is essential is that the application of the advertising media to the caps 1 occurs completely independently of and de-coupled from the processes occurring in the bottle filling system. The work steps that occur in the bottle filling systems are thus completely unaffected by the inventive application of the advertising media.

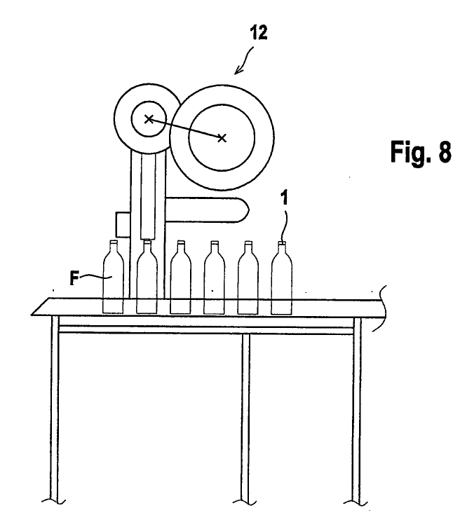

FIG. 8 illustrates one alternative embodiment of the inventive apparatus 6. In this case, the caps 1 are not fed as separate units to a labeling machine 12, but rather are already applied to the bottles. The bottles are labeled F in FIG. 8. Like the exemplary embodiment in accordance with FIG. 2, the bottles with the caps 1 travel on a conveyor belt 35. Again, allocated thereto are positioning means by means of which the bottles are positioned in the pre-determined target positions.

The labels 13 as advertising media are applied to the caps 1 in these target positions.

Preferably downstream of the labeling machines 12 illustrated in FIG. 8 is a disinfecting unit 20 by means of which the top sides of the caps 1 are sterilized. Preferably the top sides of the caps 1 are subjected to UV radiation.

The apparatus 6 thus embodied in accordance with FIG. 8 can be integrated as a modular unit simply and without great adaptation complexity.

The present invention may be embodied in other specific forms without departing from its spirit or essential characteristics. The described embodiments are to be considered in all respects only as illustrative and not as restrictive. The scope of the invention is, therefore, indicated by the appended claims and their combination in whole or in part rather than by the foregoing description. All changes that come within the meaning and range of equivalency of the claims are to be embraced within their scope.

1-35. (canceled)

36. A method for applying advertising media to bottles comprising the steps of:
continuously conveying caps or sealing parts for bottles to pre-specified target positions;
applying labels comprising advertising media to said caps or sealing parts disposed in the target positions; and
subsequently sterilizing said caps or sealing parts with said applied labels.

37. The method of claim 36, further comprising:
applying said caps or sealing parts to the bottles before continuously conveying said caps or sealing parts to the target positions.

38. The method of claim 36, further comprising:
conveying said caps to said target positions as separate units.

39. The method of claim 38, wherein said step of sterilizing said caps or sealing parts includes:
spraying said caps or sealing parts with disinfectants.

40. The method of claim 39, wherein said disinfectants comprise:
peracetic acid or hydrogen peroxide.

41. The method of claim 38, wherein said step of sterilizing said caps or sealing parts includes:
applying UV radiation.

42. The method of claim 41, wherein said step of sterilizing said caps or sealing parts includes:
sterilizing all surfaces of said caps or sealing parts.

43. The method of claim 42, wherein:
said caps further comprise covers and body parts;
said step of applying labels comprises applying labels to said cap body parts; and
said method further comprises:
applying said cap covers after applying said labels to said cap body parts.

44. The method of claim 43, further comprising:
snapping, locking, or pushing said cap covers onto said cap body parts.

45. The method of claim 44, further comprising:
detachable attaching said cap covers to said cap body parts.

46. The method of claim 45, wherein said caps are screw-on caps or rolled-on caps.

47. The method of claim 36, wherein said caps are crown seals or tube caps.

48. The method of claim 47, wherein said caps are metal and/or plastic.

49. The method of claim 48, wherein said labels are self-stick labels.

50. The method of claim 49, wherein said labels comprise:
paper and/or plastic.

51. The method of claim 50, wherein said labels comprise:
a plurality of carrier coatings.

52. The method of claim 51, wherein said labels comprise:
printed material.

53. The method of claim 52, further comprising:
applying said printed material on said labels by letterpress printing, digital printing, screen printing, and/or offset printing.

54. The method of claim 53, further comprising:
applying diffusion films, reflective films, or fluorescent films to said labels.

55. The method of claim 54, further comprising:
applying rub-off coatings to said labels.

56. The method of claim 55, further comprising:
applying temperature-sensitive color coatings to said labels.

57. The method of claim 56, wherein said labels comprise:
embossing and/or punches.

58. The method of claims 57, wherein the bottles store mineral water, fruit juice, beer, or lemonade.

59. An apparatus for performing the method of claim 36, comprising:
conveying means for transporting said caps to the pre-specified target positions;
at least one labeling machine for applying said labels to a top side of said caps disposed in the target positions; and
the at least one labeling machine being a modular unit capable of being integrated into a bottle filling system.

60. An apparatus for performing the method of claim 36, comprising:
at least one separating unit, said separating unit separating said caps or sealing parts;
conveying means for feeding said separated caps or sealing parts into the pre-specified target positions;
at least one labeling machine, said labeling machine applying said labels to said caps or sealing parts disposed in said target positions;
at least one disinfecting unit, said disinfecting unit receiving and sterilizing said caps or sealing parts provided with said labels, said disinfecting unit applying said caps or sealing parts with UV radiation or disinfectants; and
at least one supply container and an air-tight connector, said supply container receiving said sterilized caps or sealing parts via said air-tight connector for sterile storage.

61. The apparatus of claim 60, wherein:
said disinfecting unit comprises a conveyor for conveying said caps along a pre-specified path; and
at least one spray unit for spraying disinfectant on all sides of said conveyed caps or sealing parts.

62. The apparatus of claim 61, wherein:
said disinfecting unit comprises an output, said disinfecting unit applying compressed purified air at said output to said sterilized caps or sealing parts.

63. The apparatus of claim 60, wherein:
said disinfecting unit comprises a conveyor and UV radiation sources, said radiation sources emitting UV radiation; and
said conveyor of said disinfecting unit transporting, at pre-specified intervals, said caps or sealing parts past said UV radiation sources so that all sides of said caps or sealing parts are exposed to UV radiation.

64. The apparatus of claim 63, further comprising:
an octabin;
said supply container comprising a plastic bag disposed in said octabin; and
a flange forming said air-tight connector between said supply container and said disinfecting unit.

65. The apparatus of claim 64, wherein:
said separating unit comprises a centrifugal sorter.

66. The apparatus of 65, wherein:
said conveying means comprises a conveyor segment for transporting said separated caps or sealing parts;
said at least one labeling machine comprises a plurality of labeling machines; and
said apparatus further comprising at least one switch for feeding said caps or sealing parts between said plurality of labeling machines.

67. The apparatus of claim 66, wherein:
said plurality of labeling machines are identical with each other.

68. The apparatus of claim 66, wherein:
each of said plurality of labeling machines includes sensors for detecting whether said caps or sealing parts are disposed in the target-position.

69. The apparatus of claim 68, wherein:
each labeling machine comprises mechanical means for guiding said caps or sealing parts, said mechanical means transporting said caps or sealing parts at a pre-specified rate to the target positions.
